(19) United States
(12) Patent Application Publication
(10) Pub. No.: US 2012/0133966 A1
(43) Pub. Date: May 31, 2012

(54) IMAGE PROCESSING APPARATUS, CONTROL METHOD THEREOF AND STORAGE MEDIUM

(75) Inventor: Ritsuto Sako, Kawasaki-shi (JP)

(73) Assignee: CANON KABUSHIKI KAISHA, Tokyo (JP)

(21) Appl. No.: 13/301,678

(22) Filed: Nov. 21, 2011

(30) Foreign Application Priority Data
Nov. 29, 2010 (JP) 2010-265098

(51) Int. Cl. G06F 3/12; G06K 15/00

(52) U.S. Cl. 358/1.13

(57) ABSTRACT

When an MFP receives an operation screen from an external apparatus, it also receives information about specific hardware resource of the MFP to be used for the image processing based on the operation screen. When the image processing cannot be executed using the specific hardware resource of the MFP due to the error that has occurred in the MFP, the error screen is controlled not to be displayed.

### BACKGROUND OF THE INVENTION

1. Field of the Invention

The present invention relates to an image processing apparatus, a control method thereof, and a storage medium.

2. Description of the Related Art

An image processing apparatus such as a multifunction peripheral (MFP) is generally known, in which hardware resources such as a scanner, a printer, a fax machine, and a network transmission device are included in one casing.

A form of using a web browser via an operation unit included in an image forming apparatus is also generally known. As a form for using an image processing function provided by each hardware resource described above via an operation screen displayed by the web browser, a method discussed in Japanese Patent Application Laid-Open No. 2008-003833 is known.

According to Japanese Patent Application Laid-Open No. 2008-003833, based on screen information received from an external apparatus on the network, the web browser first displays the operation screen of the image processing functions on the operation screen. Upon receiving a user's operation via the operation screen, the web browser once transmits the content of the user's operation to the external apparatus.

As a response for the content of the transmitted operation, the web browser receives a script (instruction for executing image processing) from the external apparatus. Based on the received script, the web browser generates a simple object access protocol (SOAP) message to call a web service provided by the image processing apparatus, and then transmits the generated SOAP message to the provider of the web service so as to use the image processing function as the web service.

Further, when an error such as a jam or no tonner occurs, some MFPs perform control for displaying an error screen described below. For example, when displaying the operation screen for executing copy processing using a printer while the tonner is out, since the copy processing uses the printer, it displays the error screen indicating no tonner.

On the other hand, when displaying the operation screen for executing scanning processing using a scanner while the toner is out, since the scanning processing does not use the printer, it does not display the error screen indicating no toner.

However, a configuration of Japanese Patent Application Laid-Open No. 2008-003833 cannot control to display the error screen described above. That is because, until receiving an instruction for executing the image processing from the external apparatus and actually executing it, the MFP itself cannot grasp which hardware resource of the MFP is to be used.

### SUMMARY OF THE INVENTION

The present invention is directed to an image processing apparatus, a control method thereof capable of receiving information about a specific hardware resource to be used in processing based on an execution instruction received from an external apparatus and, based on an error type and the information about the specific hardware resource, performing control for displaying an error screen.

According to an aspect of the present invention, an image processing apparatus capable of displaying an operation screen based on screen information includes a request unit configured to request the screen information from an external apparatus, a first reception unit configured to receive from the external apparatus the screen information requested by the request unit, a display unit configured to display the operation screen based on the screen information received by the first reception unit, a notification unit configured to notify the external apparatus that execution of image processing using a specific hardware resource included in the image processing apparatus is instructed via the operation screen, a second reception unit configured to receive an instruction for executing the image processing using the specific hardware resource corresponding to notification issued by the notification unit, a processing unit configured to process the image processing using the specific hardware resource based on the execution instruction, a third reception unit configured to receive from the external apparatus the information about the specific hardware resource to be used by the processing unit, and a control unit configured to control the display unit to display an error screen indicating the error, when the image processing can be executed using the specific hardware resource due to an error that has occurred in the image processing apparatus, and to display the operation screen without displaying the error screen indicating the error, when the image processing can be executed using the specific hardware resource when the error has occurred in the image processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall image processing system according to an exemplary embodiment of the present invention.

FIG. 2 is a block diagram illustrating a configuration of MFP according to the exemplary embodiment.

FIG. 3 is a block diagram illustrating a configuration of a web server according to the exemplary embodiment.

FIG. 4 is a block diagram illustrating a configuration of software in an overall image processing system according to the exemplary embodiment.

FIG. 5 illustrates a processing sequence performed between MFP and a web server according to the exemplary embodiment.

FIGS. 6A, 6B, 6C illustrate an example of an operation screen of MFP according to the present exemplary embodiment.

FIG. 7 illustrates an error type classification list according to the exemplary embodiment.

FIG. 8 is a flowchart illustrating a processing procedure of MFP according to the exemplary embodiment.

FIGS. 9A, 9B illustrate an example of an error screen of MFP according to the exemplary embodiment.

FIG. 10 is a flowchart illustrating a processing procedure of a web server according to the exemplary embodiment.

FIG. 11 illustrates a screen information list according to the exemplary embodiment.

FIG. 12 is a flowchart illustrating a processing procedure of MFP according to the exemplary embodiment.

FIG. 13 is a flowchart illustrating a processing procedure of a web server according to the present exemplary embodiment.

FIG. 14 is a block diagram illustrating a configuration of software in an overall image processing system according to the present exemplary embodiment.

FIG. 15 is a block diagram illustrating a configuration of software in an overall image processing system according to the present exemplary embodiment.

### DESCRIPTION OF THE EMBODIMENTS

Various exemplary embodiments, features, and aspects of the invention will be described in detail below with reference to the drawings.

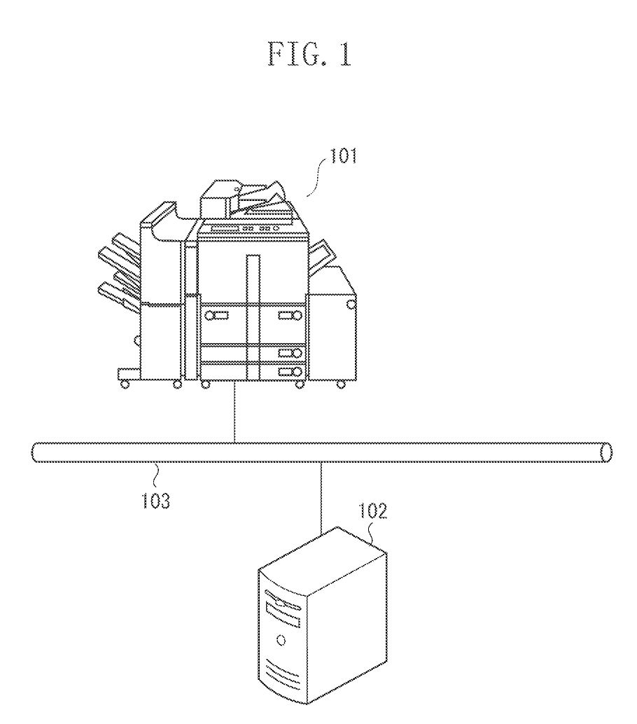

FIG. 1 illustrates an overall image processing system according to an exemplary embodiment of the present invention.

An MFP 101 and a web server 102 are mutually, communicably connected to each other via a local area network (LAN) 103. A form for connecting the MFP 101 and the web server 102 is not limited to the LAN, and the system according to the present exemplary embodiment can be realized by any other connecting method such as an internet and a radio communication.

Further, although the MFP will be described as an example of an image processing apparatus, the image processing apparatus of the present invention is not limited thereto, and a single function peripheral such as a scanner and a printer may be also used.

Furthermore, although the web server will be described as an example of an external apparatus, the external apparatus is not limited thereto, and other MFPs and personal computers (PCs) may be also used.

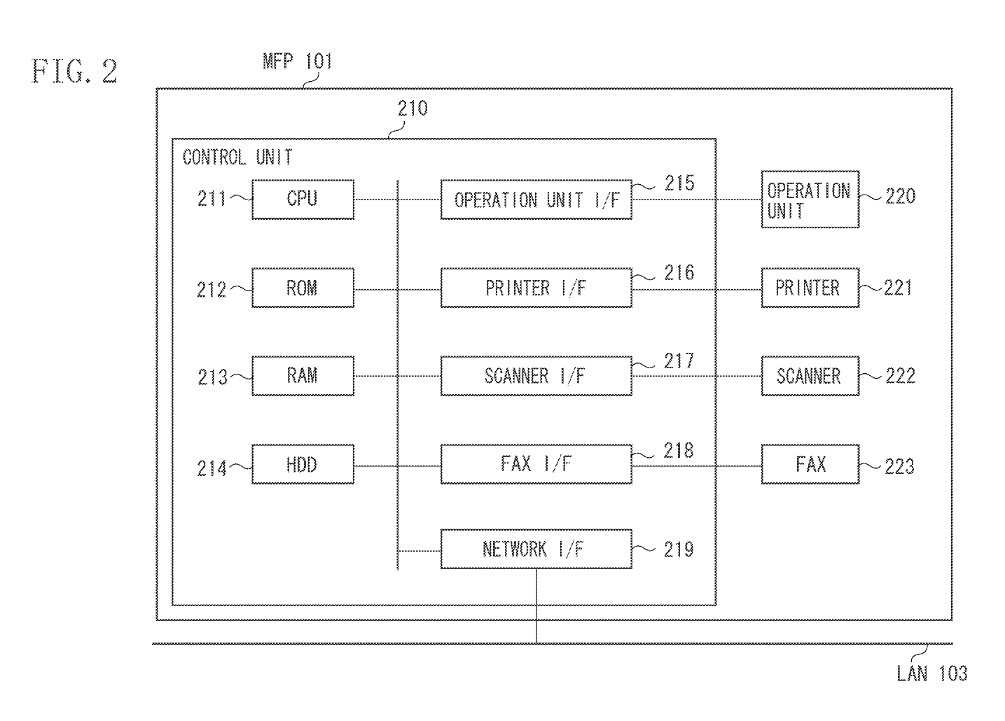

FIG. 2 is a block diagram illustrating a configuration of hardware of the MFP 101.

A control unit 210 including a central processing unit (CPU) 211 performs overall control on the MFP 101. The CPU 211 reads a control program stored in a read-only memory (ROM) 212 or a hard disk drive (HDD) 214 to control an overall apparatus.

The ROM 212 stores various information including the control program for executing processing of each flowchart described below, an error type classification list 700 described below, and screen information for displaying an operation screen on an operation unit 220. A random access memory (RAM) 213 is used as a region for temporarily storing a main memory of the CPU 211 and a work area.

Similar to the ROM 212, the HDD 214 stores various pieces of information including the control program for executing processing of each flowchart described below, the error type classification list 700 described below, and screen information for displaying the operation screen on an operation unit 220.

An operation unit interface (I/F) 215 connects the operation unit 220 and the control unit 210 to each other. The operation unit I/F 215 outputs the screen information to be displayed on the operation unit 220 thereto, and conveys the information input by a user via the operation unit 220 to the CPU 211. The operation unit 220 includes a display unit (liquid crystal display unit having a touch panel function) and a keyboard.

Further, the MFP 101 has a web browser function, and the web browser of the MFP 101 analyzes hypertext markup language (HTML) data received from the web server 102 to display the operation screen based on description of the received HTML data on the liquid display unit on the operation unit 220. Furthermore, the operation unit 220 can display the operation screen, based on the screen information stored in the ROM 212 and the HDD 214.

A printer I/F 216 connects the printer 221 and the control unit 210 to each other. Image data to be printed by the printer 221 is transferred from the control unit 210 to the printer 221 via the printer I/F 216, and then print processing for printing the image data onto a storage medium such as paper is executed.

A scanner I/F 217 connects a scanner 222 and the control unit 210 to each other. The scanner 222 reads a document to generate image data, and then executes reading processing for inputting the read image data into the control unit 210 via the scanner I/F 217.

A fax machine I/F 218 connects a fax machine 223 and the control unit 210 to each other. The fax machine 223 executes fax transmission processing for transmitting the image data read and generated by the scanner 222.

The network I/F 219 connects the control unit 210 (MFP 101) to the LAN 103. The network I/F 219 performs communication of transmitting various information such as the image data to an external apparatus (e.g., web server 102) on the LAN 103 and receiving various pieces of information therefrom.

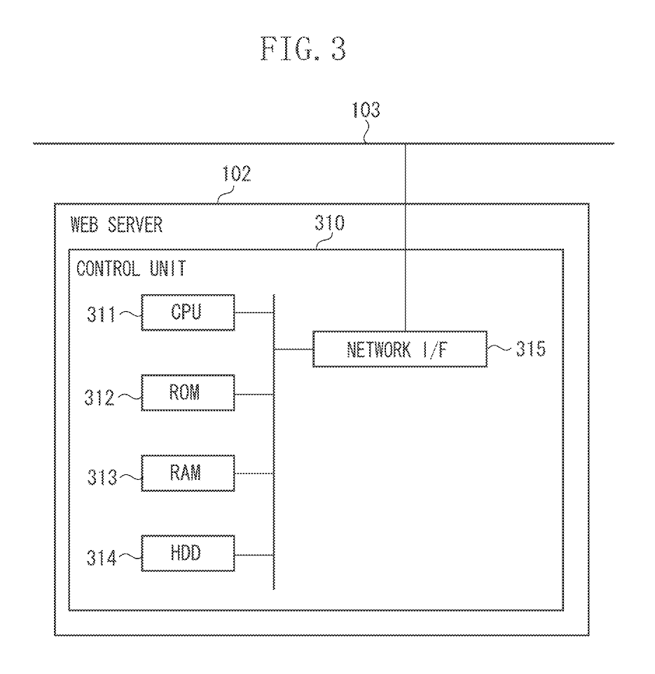

FIG. 3 is a block diagram illustrating a configuration of the hardware of the web server 102.

A control unit 310 including the CPU 311 performs overall control on the web server 102. A CPU 311 reads the control program stored in a ROM 312 or a HDD 314 and executes various control processing.

The ROM 312 stores the control program for executing the processing of the flowchart described below and various pieces of information such as a screen information list 1100 of the MFP described below.

A RAM 313 is used as a main memory of the CPU 311 and the work area temporary storage region such as a main memory and a work area. Similar to the ROM 312, the HDD 314 stores various pieces of information including the screen information list 1100 of the MFP described below and the control program for executing processing of each flowchart described below.

A network I/F 315 connects the control unit 310 to the LAN 103. The network I/F 315 transmits/receives various information between the control unit 310 and other apparatus (e.g., MFP 101) on the LAN 103.

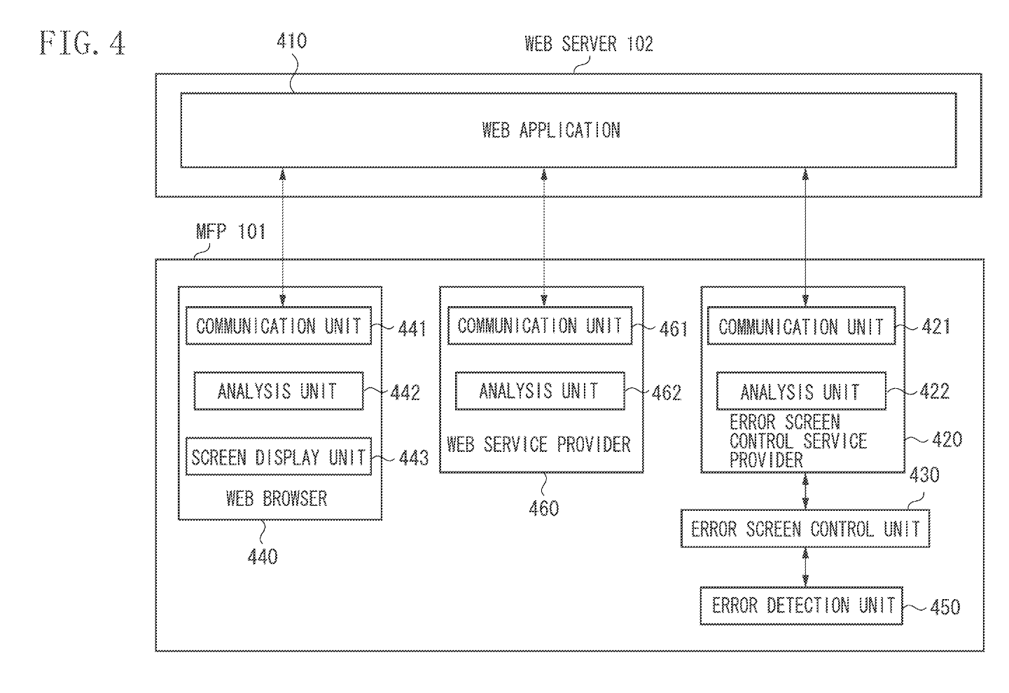

FIG. 4 illustrates a configuration of software of the overall image processing system according to the present exemplary embodiment. A software function illustrated in FIG. 4 can be realized when the CPU included in each of the MFP 101 and the web server 102 illustrated in FIGS. 2, 3 respectively executes the control program.

The MFP 101 includes a web service provider 460, an error screen control service provider 420, an error screen control unit 430, an error detection unit 450, and a web browser 440.

The web service provider 460 includes a communication unit 461 and an analysis unit 462. The web service provider 460 uses specific hardware resource (e.g., printer 221, scanner 222, and machine 223) of the MFP 101 to provide the web service to a web application 410.

A communication unit 461 receives an instruction for executing image processing transmitted from the web application 410 according to the hyper-text transfer protocol (HTTP) via the network I/F 219. An analysis unit 422 analyzes the execution instruction received by the communication unit 461, and then causes a processing execution application (not illustrated) to execute the processing.

The error screen control service provider 420 is an application including a communication unit 421 and an analysis unit 422, and receives from the web application 410 the information about the specific hardware resource of the MFP 101 to be used for the image processing, which is executed based on the execution instruction received from the web application 410.

The specific hardware resource of the MFP 101 to be used for the image processing, which is executed based on the execution instruction received from the web application 410, is referred to as the “specific hardware resource of the MFP 101 to be used for the image processing”.

The communication unit 421 receives the information about the specific hardware resources of the MFP 101 to be used for the image processing transmitted according to the HTTP from the web application 410 via the network I/F 219.

The analysis unit 422 analyzes the information about the specific hardware resources of the MFP 101 to be used for the image processing received by the communication unit 421. As a result of analysis, the analysis unit 422 notifies the 430 of the information about the specific hardware resource of the MFP 101 to be used for the image processing.

An error detection unit 450 detects an error that has occurred in the MFP 101, and notifies the error screen control unit 430 of the detected error. Further, the error detection unit 450 detects that a user's operation has solved the error that has occurred in the MFP 101, and then notifies the error screen control unit 430 that the error has been solved.

An error screen control unit 430 controls, based on the information about the specific hardware resources of the MFP 101 to be used for the image processing and a type of the error that has occurred in the MFP 101, the screen to be displayed on the operation unit 220.

A web browser 440 includes a communication unit 441, an analysis unit 442, and a screen display unit 443. The communication unit 441 communicates with the web application 410 via the network I/F 219 according to the HTTP.

More specifically, the communication unit 441 requests screen information for displaying a screen by using the web browser 440 to the web application 410, and receives a response transmitted from the web application 410. The analysis unit 442 analyzes the response received by the communication unit 441 from the web application 410. The screen display unit 443 displays the screen on the operation unit 220 based on the result of the analysis by the analysis unit 442.

The web server 102 includes the web application 410. The web application 410 executes processing according to each of various requests included in a message received from the MFP 101.

For example, the web server 102 generates the screen information about the operation screen to be displayed by the web browser 440 of the MFP 101, and then transmits the screen information to the web browser 440. Alternatively, according to the user's operation received via the operation screen, the web server 102 generates the instruction for executing the image processing to be transmitted to the web service provider 460 of the MFP 101.

Further, the web server 102 transmits the information about the specific hardware resource of the MFP 101 to be used for the image processing to the error screen control service provider 420 of the MFP 101.

Up to here, the configuration of a system according to the present exemplary embodiment has been briefly described. Description of a flow of the processing performed by the system in the present exemplary embodiment will be described below.

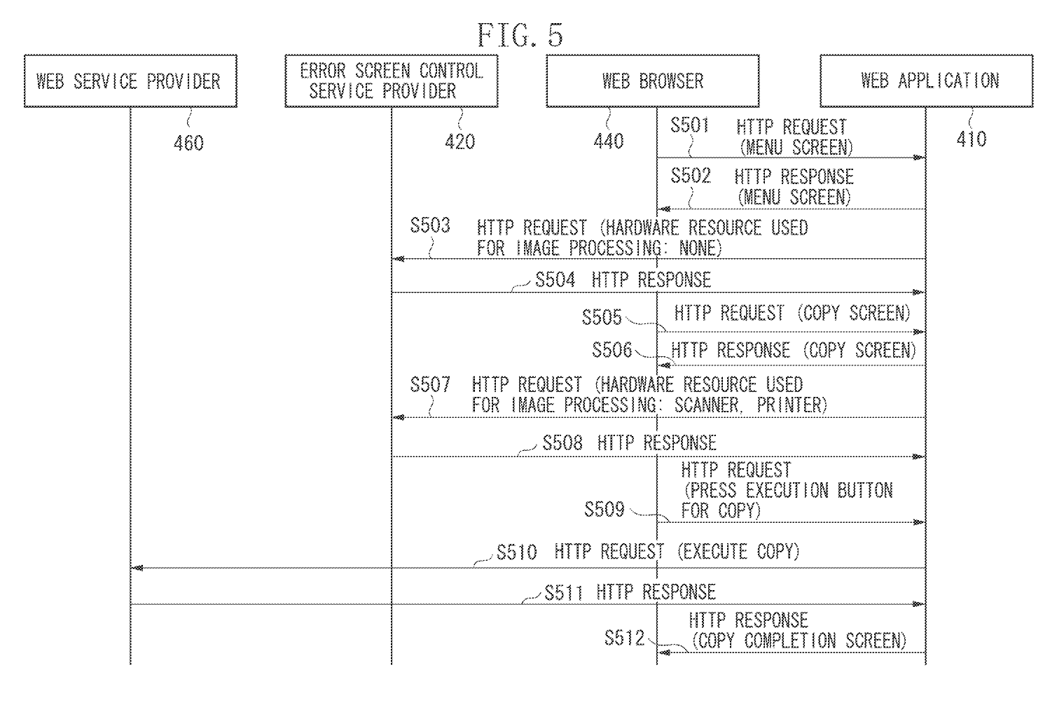

FIG. 5 is a sequence diagram illustrating a series of processing of an image processing system according to the present exemplary embodiment. The web browser 440 of the MFP 101 is activated by the user, and then, in step S501, the web browser 440 transmits an HTTP request to the web application 410. At this point, the web browser 440 requests the screen information for displaying a menu screen from the web application 410.

In step S502, the web application 410 transmits an HTTP response to the web browser 440. At this point, the web application 410 generates the screen information for displaying the menu screen, and then transmits the screen information to the web browser 440 as an HTTP response.

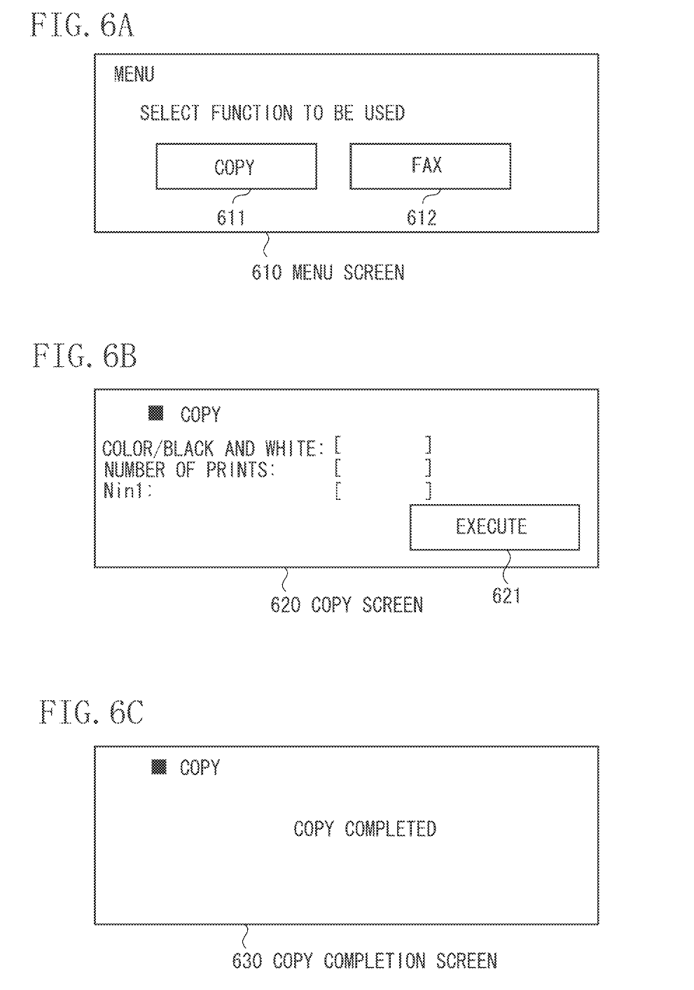

The web browser 440 analyzes the received screen information, and displays the menu screen on the operation unit 220. At this point, the menu screen displayed on the operation unit 220 is a menu screen 610 described below with reference to FIG. 6.

In step S503, the web application 410 transmits the information about the specific hardware resource of the MFP 101 to be used for the image processing to the error screen control service provider 420 as the HTTP request.

In step S502, the web application 410 transmits the screen information for displaying the menu screen 610. However, the menu screen 610 is only displayed on the operation unit 220, and which hardware resource is to be used is unknown. Therefore, the specific hardware resource of the MFP 101 to be used for the image processing is transmitted as “none”.

In step S504, the error screen control service provider 420 transmits the HTTP response indicating that the HTTP has received the HTTP request in step S503 to the web application 410.

When the specific hardware resource of the MFP 101 to be used for the image processing is not provided, the HTTP request may not be transmitted in step S503. In this case, the processing is not necessary in which the error screen control service provider 420 transmits the HTTP response to the web application 410 in step S504.

In step S505, the web browser 440 transmits the HTTP request to the web application 410 in response to the user's operation. At this point, “copy” is selected from the menu screen by the user's operation, and then the web browser 440 requests the screen information for displaying a copy screen from the web application 410.

In step S506, the web application 410 transmits the HTTP response to the web browser 440. At this point, the web application 410 generates the screen information for displaying the copy screen, and then transmits the screen information to the web browser 440 as the HTTP response.

The web browser 440 analyzes the received screen information, and displays the copy screen on the operation unit 220. At this point, the copy screen displayed on the operation unit 220 is a copy screen 620 described below with reference to FIG. 6B.

In step S507, the web application 410 transmits the information about the specific hardware resource of the MFP 101 to be used for the image processing to the error screen control service provider 420 as the HTTP request.

In step S506, the web application 410 transmits the screen information for displaying the copy screen 620. The copy processing realized on the copy screen 620 executes reading processing for reading the data to generate the image data and print processing for printing the image data. Therefore, as the specific hardware resources of the MFP 101 to be used in the reading processing and the print processing, a “scanner” and a “printer” are transmitted.

In step S508, the error screen control service provider 420 transmits to the web application 410 the HTTP response indicating that the HTTP request has been received in step S507.

Next, via the copy screen 620 to be displayed on the operation unit 220 by the web browser 440, the user inputs information for setting copy, and presses a copy execution button 621. In step S509, the web browser 440 transmits the HTTP request to the web application 410 and notifies the web application 410 that the copy execution button 621 has been pressed.

In step S510, the web application 410 generates the instruction for executing the copy processing, and transmits the instruction to the web service provider 460 as the HTTP request. The web service provider 460 analyzes the received execution instruction to cause a processing execution application (not illustrated) to execute the copy processing.

In step S511, the web service provider 460 transmits to the web application 410 the HTTP response indicating that MFP 101 has completed execution of the copy.

In step S512, the web application 410 generates the screen information for displaying a copy completion screen 630 described below with reference to FIG. 6C, and then transmits the screen information to the web browser 440 as the HTTP response.

FIGS. 6A to 6C illustrate an example of screen transition generated during a series of the processing performed by the image processing system according to the present exemplary embodiment. The web browser 440 displays each drawing illustrated in FIGS. 6A to 6C on the operation unit 220 based on the screen information received from the web application 410.

Via the menu screen 610, the user selects which function is to be used when using the function provided by the MFP 101. The menu screen 610 displays a copy button 611 and a fax button 612 as the function provided by the MFP 101.

A copy screen 620 is displayed when the user presses the copy button 611 on the menu screen 610. Via the copy screen 620, the user can set color/black and white, the number of copies, and N in 1 print, and then presses the copy execution button 621 to execute the copy.

The copy completion screen 630 is displayed when the execution of the copy has been completed.

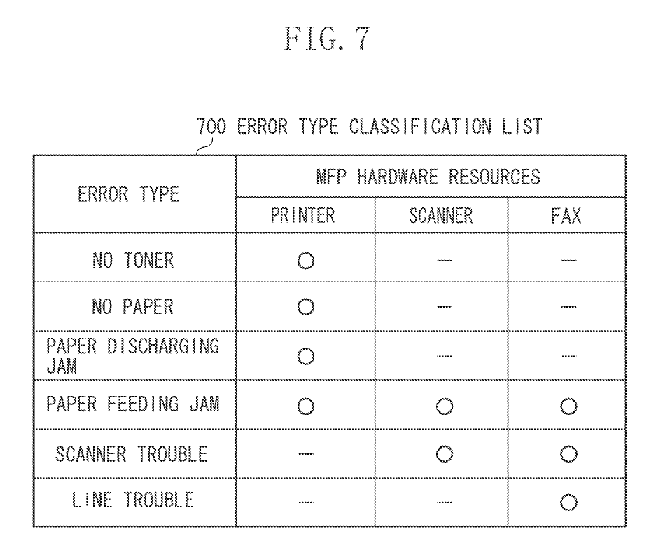

FIG. 7 illustrates the error type classification list 700 stored in the ROM 212 or the HDD 214 of the MFP 101 according to the present exemplary embodiment. The error type classification list 700 associates the error type with the hardware resource of the MFP 101 to be used for the image processing to manage them.

According to the present exemplary embodiment, the error type includes “no toner”, “no paper”, “paper discharging system jam”, “paper feeding system jam”, “scanner trouble”, and “line trouble”. Further, the “printer”, the “scanner”, and the “fax machine” are available as the hardware resource of the MFP 101 to be used for the image processing. The error type and the hardware resource of the MFP 101 to be used for the image processing are not limited to those described above.

A symbol of “o” (circle) illustrated in the error type classification list 700 indicates that the image processing cannot be executed using the hardware resource of the MFP 101 due to the error. For example, the errors of “no toner”, “no paper”, “paper discharging jam”, and “paper feeding jam” do not allow the image processing to be executed using the “printer”.

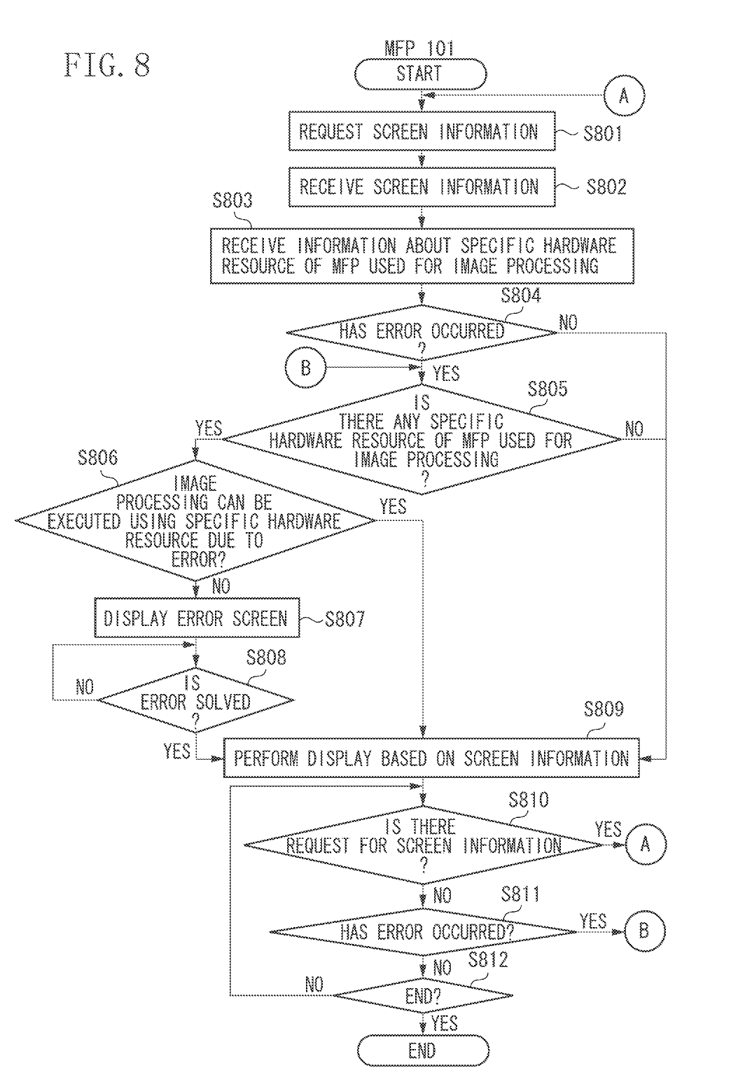

FIG. 8 is a flowchart illustrating a processing procedure executed in MFP 101 when, in the present exemplary embodiment, the user's operation generates the screen transition on the operation unit 220 and the web browser 440 requests the screen information from the web application 410. Each step of S801 to S812 can be processed when the CPU 211 included in the MFP 101 expands in the RAM 213 the program stored in the memory such as the ROM 212, and executes the program.

First, in step S801, the web browser 440 transmits a request for the screen information to the web application 410. In step S802, the web browser 440 receives from the web application 410 the screen information to be displayed on the operation unit 220.

In step S803, the error screen control service provider 420 receives from the web application 410 the information about specific hardware resource of the MFP 101 to be used for the image processing. More specifically, in step S802, if the screen information for displaying the menu screen 610 is received, the error screen control service provider 420 receives the information notifying that “none” of the specific hardware resource of the MFP 101 to be used for the image processing is available.

On the other hand, in step S802, if the screen information for displaying the copy screen 620 is received, the error screen control service provider 420 receives the information notifying that the “scanner” and the “printer” are available as the specific hardware resources of the MFP 101 to be used for the image processing.

In step S804, the CPU 211 determines whether any error occurs in the MFP 101. The error illustrated in the error type classification list 700 is conceivable as the error that may occur in the MFP 101, but the error is not limited to those described above.

In step S804, when CPU 211 determines that the error has not occurred in the MFP 101 (NO in step S804), the processing proceeds to step S809. In step S809, based on the screen information received from the web application 410, the screen display unit 443 displays the operation screen. On the other hand, in step S804, when the CPU 211 determines that the error has occurred in the MFP 101 (YES in step S804), the processing proceeds to step S805.

In step S805, the CPU 211 determines whether the specific hardware resource of the MFP 101 to be used for the image processing is available. The CPU 211 makes this determination based on the information about the specific hardware resources of the MFP 101 to be used for the image processing received in step S803.

For example, if the information notifying that “none” of the specific hardware resources of the MFP 101 to be used for the image processing is available is received, the CPU 211 determines that the specific hardware resource of the MFP 101 to be used for the image processing is not provided (NO in step S805), the processing proceeds to step S809. On the other hand, if the information notifying that the “scanner” and the “printer” are available as the specific hardware resources of the MFP 101 to be used for the image processing, the CPU 211 determines that the specific hardware resources of the MFP 101 to be used for the image processing is provided (YES in step S805), and the processing proceeds to step S806.

In step S806, the CPU 211 determines whether the image processing can be executed using the specific hardware resource when the error has occurred in the MFP 101. The determination will be described below more specifically.

If the “printer” and the “scanner” are available as the specific hardware resources of the MFP 101 to be used for the image processing, and the error that has occurred in the MFP 101 is “line trouble”, it can be known, according to the error type classification list 700, that the image processing can be executed using the “printer” and the “scanner” when the error of the “line trouble” has occurred.

Therefore, the CPU 211 determines that the image processing can be executed using the “printer” and the “scanner” when the error has occurred in the MFP 101 (YES in step S806), and the processing proceeds to step S809.

Further, if the “printer” and the “scanner” are available as the specific hardware resources of the MFP 101 to be used for the image processing, and the error that has occurred in the MFP 101 is “no toner”, it can be known, according to the error type classification list 700, that the image processing cannot be executed using the “printer” due to the error of “no tonner”. Therefore, the CPU 211 determines that the image processing cannot be executed using the “printer” and the “scanner” due to the error that has occurred in the MFP 101 (NO in step S 806), and the processing proceeds to step S807.

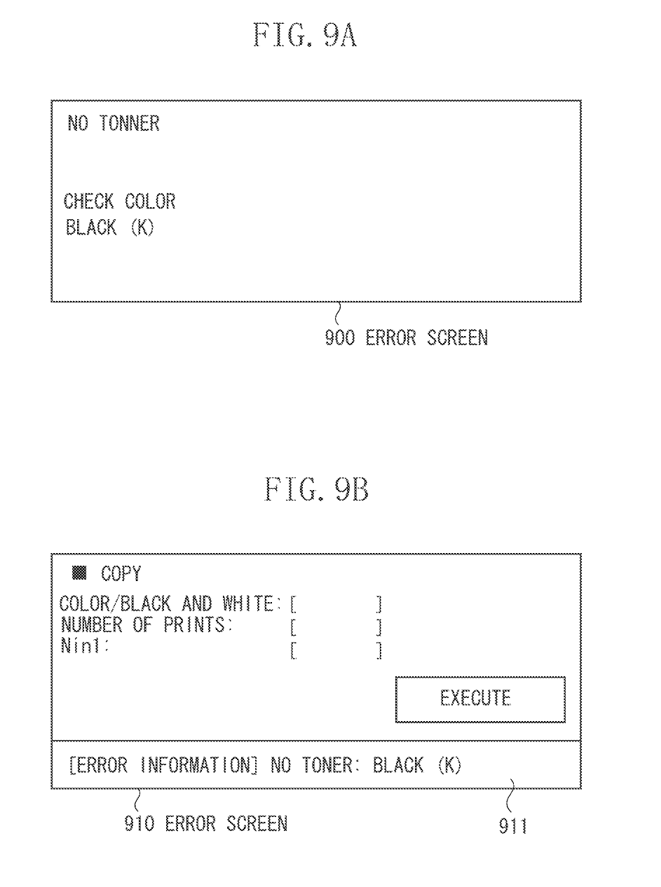

In step S807, the operation unit 220 displays the error screen. FIGS. 9A and 9B illustrates an error screen 900 as an example of the error screen displayed in step S807. The error screen 900 is displayed when the error of “no toner” has occurred in the MFP 101, and the screen information for displaying the error screen 900 is previously stored in the ROM 212 or the HDD 214 of the MFP 101.

Regarding other errors that may occur in the MFP 101, the error screen corresponding to each error is stored in the ROM 212 or the HDD 214 of the MFP 101.

As described above, by preparing the screen information for displaying the error screen in the MFP 101 not in the web application 410 (web server 102), the effects can be obtained as follows. More specifically, since the screen information for displaying the error screen does not need to be received from the web application 410, for example, even when a network trouble disturbs communication with the web application 410, an appropriate error screen can be displayed.

Display of the error screen in step S807 is not limited to those described above, and a display method described below is also available.

First, the CPU 211 notifies the web application 410 of the error that has occurred in the MFP 101, and receives from the web application 410 the screen information for displaying the error screen indicating the notified error. Based on the screen information, the operation unit 220 displays the error screen similar to the error screen 900. By adopting such a display method, the web application 410 can provide the unique error screen, for example, on which a method for solving the error is described in detail.

Second, as illustrated in an error screen 910 at a part of region of the operation screen, information about the error that has occurred in the MFP 101 is displayed. The error screen 910 displays in a status bar 911 the information about the error that has occurred in the MFP 101. By adopting such a display method, the error can be notified while the operation screen is being displayed.

Returning to the description of the flowchart illustrated in FIG. 8, in step S808, the CPU 211 determines whether the error that has occurred in the MFP 101 has been solved. In step S808, when the CPU 211 determines that the error has been solved, the processing proceeds to step S809.

In step S810, the CPU 211 determines whether the user's operation generates the screen transition on the operation unit 220 and a request for new screen information is generated. When the CPU 211 determines that the request for the new screen information has been generated (YES in step S810), the processing returns to step S801.

In step S811, the CPU 211 determines whether a new error has occurred. Since this determination is made in the same procedure as that in step S804, the description is not repeated. When the CPU 211 determines that the new error has occurred in step S811 (YES in step S811), the processing returns to step S805.

By making the determination in step S811, display on the error screen can be controlled by being triggered by occurrence of the new error when the operation screen is being displayed based on the received screen information in step S802.

In step S812, the CPU 211 determines whether the processing of this flowchart ends. For example, the CPU 211 determines that, when the user ends to use the web browser 440, or the user selects an “end” on the screen displayed on the operation unit 220, the processing of this flowchart ends (YES in step S812).

As described above, as illustrated by the flowchart in FIG. 8, if the image processing can be executed using the specific hardware resources of the MFP 101 when the error has occurred in the MFP 101, not notifying the error on the error screen can be controlled.

Therefore, since the error that has nothing to do with the operation screen displayed by the operation unit 220 can be controlled not to be displayed, for example, even if the display region in the operation unit 220 is small, the display region can be effectively used.

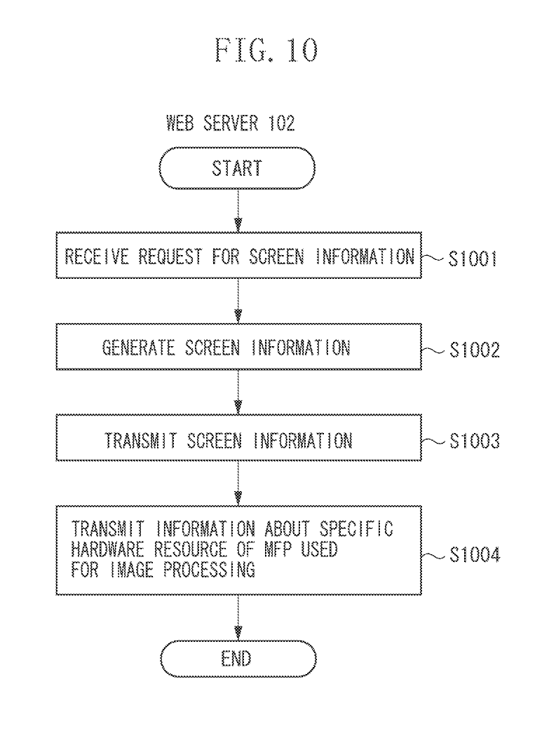

FIG. 10 is a flowchart illustrating the processing to be executed by the web server 102 that has received the request for the screen information transmitted by the MFP 101 in step S801 illustrated in FIG. 8. Each step of S1001 to S1004 can be processed when the CPU 311 included in the web server 102 loads in the RAM 313 the program stored in the memory such as the ROM 312, and executes the program.

In step S1001, the web application 410 receives the request for the screen information transmitted by the MFP 101. In step S1002, the web application 410 generates the appropriate screen information to be transmitted to the MFP 101.

In step S1003, the web application 410 transmits the screen information generated in step S1002 to the communication unit 441 of the web browser 440.

In step S1004, the web application 410 transmits the information about the specific hardware resources of the MFP 101 to be used for the image processing to the communication unit 421 of the error screen control service provider 420.

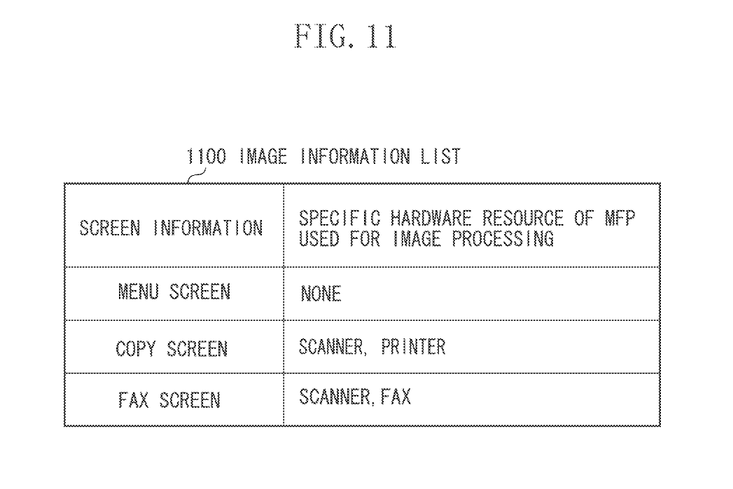

At this point, to transmit the information about the specific hardware resources of the MFP 101 to be used for the image processing, a list to which the web application 410 refers is indicated in the screen information list 1100 illustrated in FIG. 11. According to the present exemplary embodiment, the screen information list 1100 is stored in the ROM 312 or the HDD 314 of the web server 102.

The screen information list 1100 associates a type of the screen information to be transmitted to the MFP 101 with the specific hardware resource of the MFP 101 to be used for the image processing based on the screen information to manage them. According to the screen information list 1100, for example, since the image processing is not performed on the “menu screen”, it can be known that “none” of the specific hardware resources of the MFP 101 is available.

Further, since the copy processing is performed on the “copy screen”, it can be known that the “scanner” and the “printer” are available as the specific hardware resources of the MFP 101 to be used for the image processing. The information managed by the screen information list 1100 is not limited to the information described above, and other screen information may be associated with specific hardware resource of the MFP 101 to be used for the image processing for management.

Returning to the description of the flowchart, in step S1004, the web application 410 transmits to the error screen control service provider 420 the information about the hardware resources of the MFP 101 to be used for the image processing. For example, if the screen information for displaying the copy screen 620 is transmitted in step S1003, the “scanner” and the “printer” are transmitted as the available hardware resources of the MFP 101 to be used for the image processing.

As described above, in response to the request for the screen information from the MFP 101, the web server 102 can generate the appropriate screen information, and transmit it to the MFP 101. Further, the information about the specific hardware resources of the MFP 101 to be used for the image processing can be transmitted to the MFP 101.

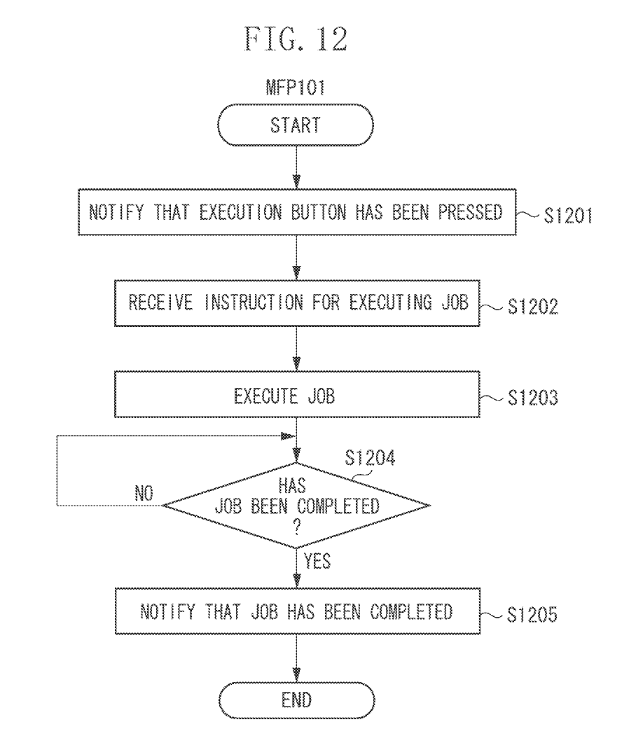

FIG. 12 is a flowchart illustrating a processing procedure of a certain processing executed by the user's operation via the operation screen displayed on the operation unit 220 by the web browser 440. Each step of S1201 to S1205 can be processed when the CPU 211 included in the MFP 101 loads in the RAM 213 the program stored in the memory such as the ROM 212, and executes the program.

According to the flowchart illustrated in FIG. 12, the operation unit 220 displays the copy screen 620 as an example, and the user inputs information for setting the copy, and then presses the copy execution button 621. In step S1201, the web browser 440 notifies the web application 410 of the copy execution button 621 being pressed and the setting information input by the user.

In step S1202, the web service provider 460 receives an instruction for executing a job from the web application 410, and then, based on the execution instruction, the job is executed in step S1203. According to the present exemplary embodiment, the copy processing is executed.

In step S1204, the CPU 211 determines whether the executed job has been completed. When the CPU 211 determines that the job has been completed (YES in step S1204), in step S1205, the web service provider 460 notifies the web application 410 that the job has been completed.

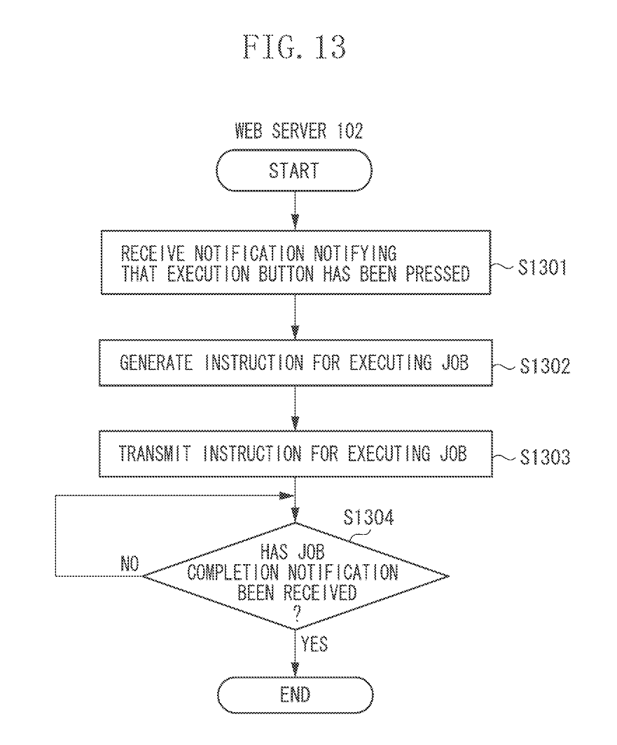

FIG. 13 is a flowchart illustrating the processing executed by the web server 102 that has received the notification transmitted by the MFP 101 in step S1201 illustrated in FIG. 12. Each step of S1301 to S1304 can be processed when the CPU 311 included in the web server 102 loads in the RAM 313 the program stored in the memory such as the ROM 312 and executes the program.

According to the flowchart illustrated in FIG. 13, similar to the flowchart illustrated in FIG. 12, the copy screen 620 is displayed on the operation unit 220 of the MFP 101 as an example, and the user inputs the information for setting the copy, and then presses the copy execution button 621.

In step S1301, the web application 410 receives from the web browser 440 the notification of the copy execution button 621 being pressed and the setting information input by the user.

In step S1302, based on the notification received in step S1301, the instruction for executing the job to be transmitted to the web service provider 460 is generated. In step S1303, the web application 410 transmits the instruction for executing the job is transmitted to the web service provider 460.

In step S1304, the CPU 311 determines whether the notification of completing the job has been received from the web service provider 460. When the CPU 311 determines that the notification of completing the job has been received from the web service provider 460 (YES in step S1304), the processing of the flowchart illustrated in FIG. 13 ends. Further, in step S1304, when the CPU 311 determines that the notification of completing the job has been received from the web service provider 460 (YES in step S1304), the screen information to be transmitted to the web browser 440 may be generated to transmit it to the web browser 440.

As described above, according to the present exemplary embodiment, when the MFP receives the operation screen from the web server, the information about the specific hardware resource of the MFP to be used for the image processing that is to be realized on the operation screen is also transmitted from the web server to the MFP. Therefore, according to whether the image processing received from the external apparatus can be executed using the specific hardware resource of the MFP due to the error that has occurred in the MFP, the display of the error screen can be controlled.

According to the first exemplary embodiment, the web application 410 communicates with each of the web browser 440, the error screen control service provider 420, and the web service provider 460. On the other hand, a second exemplary embodiment is characterized in that the script for communicating with the error screen control service provider 420 and the web service provider 460 is embedded in a response to the web browser 440, and transmitted.

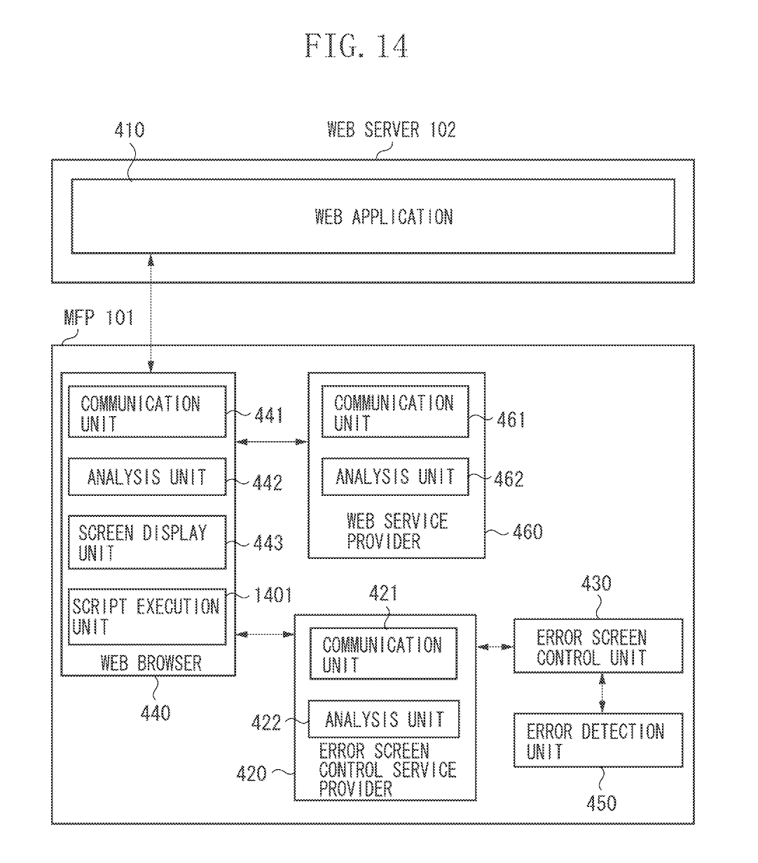

FIG. 14 illustrates a software configuration of an overall image processing system according to the present exemplary embodiment. A software function illustrated in FIG. 14 can be realized when the CPU included in each of the MFP 101 and the web server 102 illustrated in FIGS. 2, 3 respectively executes the control program. Since, in FIG. 14, the same components have the same reference numerals as those in FIG. 4, the descriptions will not be repeated.

A script execution unit 1201 executes the script embedded in the HTTP response transmitted from the web application 410. According to a result of executing the script, the script execution unit 1201 transmits the information about the specific hardware resource of the MFP 101 to be used for the image processing to the error screen control service provider 420.

Further, according to the result of executing the script, the script execution unit 1201 transmits the instruction for executing the image processing transmitted from the web application 410 to the web service provider 460.

According to the present exemplary embodiment, the communication performed by the web application 410 with the error screen control service provider 420 and the web service provider 460 is included in the HTTP response to the web browser 440. Therefore, even if a fire wall is provided between the web server 102 and the MFP 101, the communication can be performed.

According to the first exemplary embodiment, the error screen control service provider 420 is provided to control the display of the error screen. On the other hand, a third exemplary embodiment is characterized in that the web browser 440 is provided with an error screen control unit 1501 for controlling the display of the error screen. At this point, the response to the web browser 440 includes the information about the specific hardware resource of the MFP 101 to be used for the image processing.

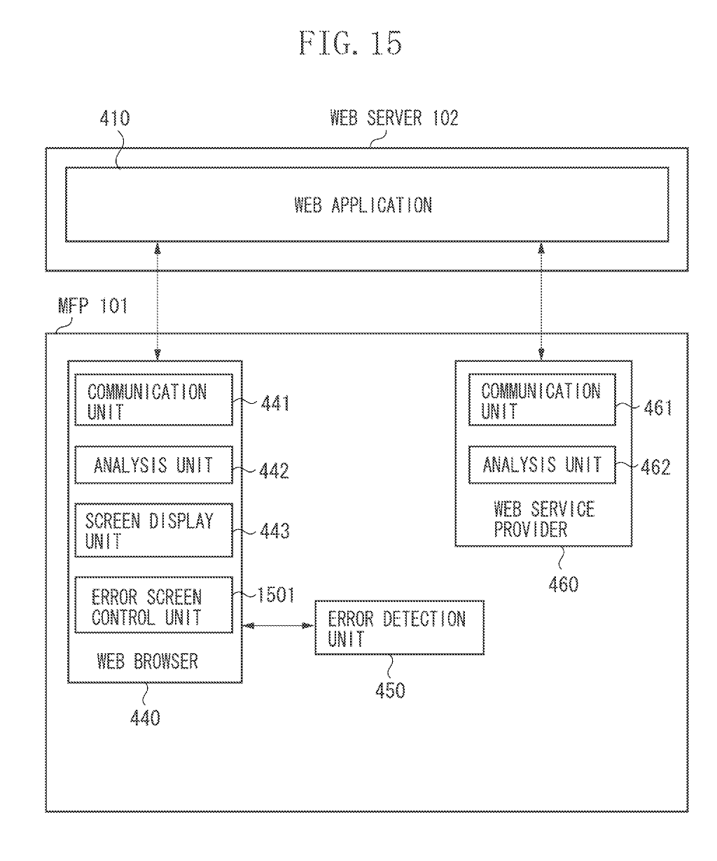

FIG. 15 is a block diagram illustrating the software configuration of the overall image processing system according to the present exemplary embodiment. The software function illustrated in FIG. 15 can be realized when the CPU included in each of the MFP 101 and the web server 102 illustrated in FIGS. 2, 3 respectively executes the control program. Since, in FIG. 15, the same components have the same reference numerals as those in FIG. 4, the descriptions will not be repeated.

The web browser 440 includes an error screen control unit 1501 for controlling the display of the error screen. According to the present exemplary embodiment, the response to the web browser 440 transmitted from the web application 410 includes the information about the specific hardware resource of the MFP 101 to be used for the image processing.

The analysis unit 442 analyzes the response. Based on the type of the error that has occurred in the MFP 101 and the information about the specific hardware resource of the MFP 101 to be used for the image processing acquired from analysis by the analysis unit 442, the error screen control unit 1501 controls the display of the error screen.

According to the present exemplary embodiment, without providing the error screen control service provider 420 unlike the first exemplary embodiment, the display of the error screen can be controlled by using the web browser 440.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-265098 filed Nov. 29, 2010, which is hereby incorporated by reference herein in its entirety.

What is claimed is:

1. An image processing apparatus capable of displaying an operation screen based on screen information, the image processing apparatus comprising:
a request unit configured to request the screen information from an external apparatus;
a first reception unit configured to receive, from the external apparatus, the screen information requested by the request unit;
a display unit configured to display the operation screen based on the screen information received by the first reception unit;
a notification unit configured to notify the external apparatus that execution of image processing using a specific hardware resource included in the image processing apparatus is instructed via the operation screen;
a second reception unit configured to receive an instruction for executing the image processing using the specific hardware resource corresponding to notification notified by the notification unit;
a processing unit configured to process the image processing using the specific hardware resource based on the execution instruction;
a third reception unit configured to receive, from the external apparatus, hardware resource information about the specific hardware resource to be used by the processing unit; and
a control unit configured to control the display unit to display an error screen indicating an error that has occurred in the image processing apparatus, when the error is associated with the specific hardware resource indicated by the hardware resource information, and to display the operation screen without displaying the error screen indicating the error, when the error is not associated with the specific hardware resource indicated by the hardware resource information.

2. The image processing apparatus according to claim 1, wherein the third reception unit receives the hardware resource information about the specific hardware resource before the second reception unit receives the execution instruction.

3. The image processing apparatus according to claim 1, wherein the third reception unit receives the hardware resource information about the specific hardware resource when the first reception unit receives the screen information.

4. The image processing apparatus according to claim 1, wherein, when the error that has occurred in the image processing apparatus is associated with the specific hardware resource indicated by the hardware resource information, the control unit controls the display unit to display the error screen indicating the error without displaying the operation screen.

5. The image processing apparatus according to claim 1, further comprising a determination unit configured to determine whether the error that has occurred in the image processing apparatus is associated with the specific hardware resource indicated by the hardware resource information,
wherein, when the determination unit determines that the error is associated with the specific hardware resource indicated by the hardware resource information, the control unit controls the display unit to display the error screen indicating the error, and
wherein, when the determination unit determines that the error that has occurred in the image processing apparatus is not associated with the specific hardware resource indicated by the hardware resource information, the control unit controls the display unit not to display the error screen indicating the error.

6. The image processing apparatus according to claim 5, further comprising a storage unit configured to store an error that may occur in the image processing apparatus and the specific hardware resource associated with each other,
wherein the determination unit determines, by referring to the storage unit, whether the error that has occurred in the image processing apparatus is associated with the specific hardware resource indicated by the hardware resource information.

7. The image processing apparatus according to claim 1, wherein the error screen is not based on screen information received from the external apparatus.

8. The image processing apparatus according to claim 1, wherein the error screen is displayed by the display unit based on the screen information stored in the image processing apparatus.

9. The image processing apparatus according to claim 1, wherein the operation screen is displayed by a web browser included in the image processing apparatus.

10. The image processing apparatus according to claim 1, wherein the image processing executed by the processing unit performs any one of print processing for printing image data, reading processing for reading original document to generate the image data, and fax transmission processing for transmitting a fax of the image data.

11. The image processing apparatus according to claim 1, wherein the specific hardware resource includes any one of a printer, a scanner, and a fax machine.

12. A method for controlling an image processing apparatus capable of displaying an operation screen based on screen information, the method comprising:
requesting the screen information from an external apparatus;
receiving, from the external apparatus, the screen information requested by the requesting;
displaying the operation screen based on the received screen information;
notifying the external apparatus that execution of image processing using a specific hardware resource included in the image processing apparatus is instructed via the operation screen;
receiving, from the external apparatus, an instruction for executing the image processing using the specific hardware resource corresponding to the notified notification;
performing the image processing using the specific hardware resource based on the execution instruction;
receiving, from the external apparatus, hardware resource information about the specific hardware resource to be used; and
controlling an error screen to be displayed, the error screen indicating a error that has occurred in the image processing apparatus, when the error is associated with the specific hardware resource indicated by the hardware resource information, and the operation screen to be displayed without displaying the error screen indicating the error, when the error is not associated with the specific hardware resource indicated by the hardware resource information.

13. A storage medium that stores a program for causing a computer to execute a method for controlling the image processing apparatus according to claim 12.
